(19) United States
(12) Patent Application Publication
(10) Pub. No.: US 2011/0317217 A1
(43) Pub. Date: Dec. 29, 2011

(54) IMAGE PROCESSING SYSTEM, MANAGEMENT APPARATUS, IMAGE PROCESSING APPARATUS, POWER CONTROL METHOD AND POWER CONTROL PROGRAM FOR IMAGE PROCESSING APPARATUS, AND RECORDING MEDIUM

(76) Inventor: Toshiyuki TANIUCHI, Osaka (JP)

(21) Appl. No.: 13/170,325

(22) Filed: Jun. 28, 2011

(30) Foreign Application Priority Data
Jun. 29, 2010 (JP) 2010-148220

(51) Int. Cl. G06F 15/00

(52) U.S. Cl. 358/1.15

(57) ABSTRACT

A control unit of the invention controls shifting of an image processing apparatus from an operation state to a standby state with a use frequency information management table, a monitoring unit and a threshold value storage unit that stores a threshold value serving as a determination criterion for shifting the image processing apparatus from the operation state to the standby state. The control unit identifies terminal apparatuses that are connected to a communication line by the monitoring unit, and obtains the use frequency information for all terminal apparatuses that have been identified to be in the connected state from the use frequency information management table and adds the obtained use frequency information, and if a total value obtained by the addition is smaller than the threshold value stored in the threshold value storage unit, outputs a signal instructing the image processing apparatus to shift to the standby state to the image processing apparatus, and if the total value is larger than or equal to the threshold value, outputs a signal instructing the image processing apparatus to maintain the operation state to the image processing apparatus.

### CROSS-REFERENCE TO RELATED APPLICATIONS

This application claims priority under 35 U.S.C. §119(a) on Patent Application No. 2010-148220 filed in Japan on Jun. 29, 2010, the entire contents of which are herein incorporated by reference.

1. Field of the Invention

The present invention relates to an image processing system that performs power control of an image processing apparatus, as well as to a management apparatus, an image processing apparatus, a power control method and a power control program for an image processing apparatus, and a recording medium.

2. Description of the Related Art

Recently, there are many cases, in which an image processing apparatus having various functions such as a copier, fax, printer or scanner function is connected to a network to which other terminal apparatuses such as personal computers are connected, and shared by the terminal apparatuses.

Under such a use environment, it is desirable to perform power saving control of the image processing apparatus while taking the relation between the image processing apparatus and the personal computers or the like that use the image processing apparatus into account, thereby achieving both user convenience and power saving for the image processing apparatus.

For example, the device related to image formation disclosed in JP 2007-124309A (hereinafter referred to as “Patent Document 1”) is configured to monitor whether a terminal activation condition is satisfied, the terminal activation condition being a state in which, of a plurality of terminals connected via a network, a predetermined specific terminal or a minimum predetermined number of terminals are activated. If the terminal activation condition is not satisfied, a stepwise power saving mode is executed, and if the terminal activation condition is satisfied, an iterative power saving mode is executed. Furthermore, the device related to image formation is configured to detect whether the terminal activation condition is satisfied while the iterative power saving mode is being executed, and if the terminal activation condition is satisfied, the iterative power saving mode is continued. If the terminal activation condition is not satisfied, the device shifts to the stepwise power saving mode.

That is, shifting of a multifunctional peripheral to the power saving mode is controlled based on whether a predetermined specific terminal (a client terminal that is frequently used) is activated (this serves as a “decision criterion 1”), or whether at least a predetermined number of terminals are activated (this serves as a “decision criterion 2”).

With the above-described decision criterion 1, while a client terminal that is frequently used is activated, there is no shift to the power saving mode. However, if a plurality of client terminals whose use frequencies are not high are activated, the total use frequency thereof (e.g., the number of times of use) may exceed the use frequency (e.g., the number of times of use) of the specific client terminal. With the decision criterion 1, a shift is made to the power saving even in such a case. Therefore, each time a print request or the like is received from a terminal, an operation for returning from the power saving mode must be performed in order to perform the print operation. This requires time of the user who uses the image processing apparatus after issuing a print command or the like until printing is actually started, which impairs user-friendliness. Also, the image processing apparatus may need to perform the return operation from the power saving mode frequently, and as a result, power saving may not be achieved.

With the above-described decision criterion 2, the configuration is such that while at least a predetermined number of the client terminals whose use frequencies are a certain level or higher are activated, there is no shift to the power saving mode. However, if a large number of client terminals whose use frequencies are lower than that certain level (whose use frequencies are relatively low) are activated, the total use frequency thereof may exceed the use frequency of the predetermined number of terminals. With the decision criterion 2, a shift is made to the power saving mode even in such a case, and thus each time a print request or the like is received from a terminal, the return operation from the power saving mode must be performed in order to perform the print operation. This requires time of the user who uses the image processing apparatus after issuing a print command until printing is actually started, which impairs user-friendliness. Also, the image processing apparatus may need to perform the return operation from the power saving mode frequently, and as a result, power saving may not be achieved.

That is, the power control method disclosed in Patent Document 1 uses the use frequency only as a condition for deciding the terminal activation condition, and after the terminal activation condition has been decided, the actual criterion for determining whether the condition is satisfied relies only on the number of active client terminals. In other words, the actual use frequency (actual number of times of use) of the multifunctional peripheral is not considered at all, so that the above-described issues may occur. This problem can be solved by considering the actual use frequency (actual number of times of use) of the multifunctional peripheral.

The present invention has been made to solve the issues described above, and it is an object thereof to provide an image processing system, a management apparatus, an image processing apparatus, a power control method and a power control program for the image processing apparatus, and a recording medium that are capable of, in an environment in which client terminal devices and an image processing apparatus can be connected via a network, fully balancing improvement of power saving and convenience of clients by considering the actual use frequency of the image processing apparatus such as the number of times of use thereof by all terminal apparatuses in a connected state instead of the number of active client terminal apparatuses.

### SUMMARY OF THE INVENTION

In order to solve the above-described issues, the image processing system of the present invention is an image processing system in which an image processing apparatus, a plurality of terminal apparatuses, and a management apparatus that manages the operation state of the image processing apparatus and the terminal apparatuses are mutually connected via a communication line, wherein the management apparatus includes: a table management unit that collects, for each terminal apparatus, use frequency information of the image processing apparatus, and manages the collected use frequency information with a use frequency information management table; a monitoring unit that monitors the connection/non-connection state of each terminal apparatus to the communication line; a threshold value storage unit that stores a threshold value that serves as a determination criterion for shifting the image processing apparatus from an operation state to a standby state; and a control unit that controls the shifting of the image processing apparatus from the operation state to the standby state, using the use frequency information management table, the monitoring unit and the threshold value storage unit, and the control unit identifies terminal apparatuses that are connected to the communication line by the monitoring unit, and obtains the use frequency information for all terminal apparatuses that have been identified to be in the connected state from the use frequency information management table and adds the obtained use frequency information, and if a total value obtained by the addition is smaller than the threshold value stored in the threshold value storage unit, outputs a signal instructing the image processing apparatus to shift to the standby state to the image processing apparatus, and if the total value is larger than or equal to the threshold value, outputs a signal instructing the image processing apparatus to maintain the operation state to the image processing apparatus.

With the above-described configuration, it is preferable that in the case where the image processing apparatus has received the signal instructing it to shift to the standby state from the management apparatus, the image processing apparatus shifts from the operation state to the standby state, and in the case where the image processing apparatus has received the signal instructing it to maintain the operation state from the management apparatus, the image processing apparatus maintains the operation state.

Furthermore, with the above-described configuration, it is preferable that the use frequency information is information on the number of times of use of the image processing apparatus.

With the present invention, the configuration is such that the image processing apparatus is shifted from the operation state (the state in which a job can be executed immediately after being received) to the standby state that is a so-called power saving mode based on the total value of the use frequency information for all terminal apparatuses connected to the system, rather than the number of the terminal apparatuses connected to the system.

Specifically, the configuration is such that the use frequency information for all terminal apparatuses in the connected state is obtained from the use frequency information management table and the obtained use frequency information is added. If the total value obtained by the addition is smaller than the threshold value stored in the threshold value storage unit, a signal instructing to shift the image processing apparatus to the standby state is output to the image processing apparatus, thereby shifting the image processing apparatus from the operation state to the standby state. In this manner, since shifting to the standby state is determined based on the actual use frequency (the total value of the actual numbers of times of use) of the image processing apparatus rather than the number of connected apparatuses, once a shift to the standby state is made, the standby state is likely to continue for a while. Accordingly, the possibility that the return operation from the standby state is frequently performed, as in the conventional techniques, decreases. That is, it is possible to fully improve both a power saving effect and convenience of users who use the image processing apparatus.

With the image processing system of the present invention, a clock unit that measures a current time may be further included, and a configuration may be adopted in which the table management unit collects, for each terminal apparatus, the use frequency information of the image processing apparatus, and manages the collected use frequency information with the use frequency information management table, for each of a plurality of time periods that have been set in advance, the threshold value storage unit stores a threshold value for each of the time periods that have been set in advance, the control unit obtains the use frequency information in a time period that includes the current time measured by the clock unit for all terminal apparatuses in the connected state from the use frequency information management table and adds the obtained use frequency information, and if a total value obtained by the addition is smaller than a threshold value that is set for that time period and stored in the threshold value storage unit, outputs a signal instructing the image processing apparatus to shift to the standby state to the image processing apparatus, and if the total value is larger than or equal to the threshold value, outputs a signal instructing the image processing apparatus to maintain the operation state to the image processing apparatus.

In the above-described configuration, the plurality of time periods may be three time periods, namely, working hours, overtime hours and non-working hours.

In this manner, by setting optimal threshold values for each of the time periods, namely, the working hours, the overtime hours, and the non-working hours, it is possible to control shifting from the operation state to the standby state at an optimal timing according to each time period.

With the image processing system of the present invention, a configuration may be adopted in which the image processing apparatus includes a scanning mode in which an image reading unit that scans a document and reads image data thereof is operated, a print mode in which a printing unit that prints the image data read by the image reading unit or image data sent from a terminal apparatus is operated, and a copy mode in which the image reading unit and the printing unit are operated, the table management unit collects, for each terminal apparatus, the use frequency information of each unit, and manages the collected use frequency information with the use frequency information management table, the threshold value storage unit stores a threshold value corresponding to the image reading unit and a threshold value corresponding to the printing unit, and the control unit obtains the use frequency information of each unit for all terminal apparatuses in the connected state from the use frequency information management table, adds the obtained the use frequency information for each unit, and compares, for each unit, the total value obtained by the addition with a threshold value set for the corresponding unit and stored in the threshold value storage unit, and if the total value is smaller than the threshold value, outputs a signal instructing the corresponding unit of the image processing apparatus to shift to the standby state to the image processing apparatus, and if the total value is larger than or equal to the threshold value, outputs a signal instructing the corresponding unit of the image processing apparatus to maintain the operation state to the image processing apparatus.

Specifically, the use frequency information of each unit is obtained for all terminal apparatuses in the connected state from the use frequency information management table, the obtained use frequency information is added for each unit, and the added total value is compared, for each unit, with a threshold value set for the corresponding unit and stored in the threshold value storage unit, and if the total value is smaller than the threshold value, the signal instructing to shift the corresponding unit of the image processing apparatus to the standby state is output to the image processing apparatus. In this manner, by determining the use state of each unit (namely, the image reading unit and the printing unit) by all terminal apparatuses in the connected state, and performing shifting processing to the standby state for each unit, finely grained power control can be performed. That is, by shifting only the corresponding unit of the image processing apparatus to the standby state, rather than shifting the entire image processing apparatus from the operation state to the standby state, power control can be performed according to the actual use state of the image processing apparatus. For example, if the total value of the use frequency information of the image reading unit for all terminal apparatuses in the connected state is smaller than the threshold value set for the corresponding unit, it is sufficient if only the image reading unit is shifted to the standby state. Also, if the total value of the use frequency information of the printing unit for all terminal apparatuses in the connected state is smaller than the threshold value set for the corresponding unit, it is sufficient if only the printing unit is shifted to the standby state.

Also, with the image processing system of the present invention, a configuration may be adopted in which the image processing apparatus includes a scanning mode in which an image reading equipment that scans a document and reads image data thereof is operated, a print mode in which a printing equipment that prints the image data read by the image reading equipment or image data sent from a terminal apparatus is operated, and a copy mode in which the image reading equipment and the printing equipment are operated, the table management unit collects, for each terminal apparatus, the use frequency information of each equipment of the image processing apparatus in each time period, and manages the collected use frequency information with the use frequency information management table, the threshold value storage unit stores, for each time period, a threshold value corresponding to the image reading equipment and a threshold value corresponding to the printing equipment, and the control unit obtains the use frequency information of each equipment in a time period that includes the current time measured by the clock unit for all terminal apparatuses in the connected state from the use frequency information management table, adds the obtained use frequency information for each equipment, and compares, for each equipment, the total value obtained by the addition with a threshold value set for the corresponding equipment and the corresponding time period and stored in the threshold value storage unit, and if the total value is smaller than the threshold value, outputs a signal instructing the corresponding equipment of the image processing apparatus to shift to the standby state to the image processing apparatus, and if the total value is larger than or equal to the threshold value, outputs a signal instructing the corresponding equipment of the image processing apparatus to maintain the operation state to the image processing apparatus.

That is, the use frequency information of each equipment in the time period that includes the current time is obtained for all terminal apparatuses in the connected state from the use frequency information management table, and the obtained use frequency information is added for each equipment. The total value obtained by the addition is compared, for each equipment, with a threshold value set for the corresponding equipment and stored in the threshold value storage unit, and if the total value is smaller than the threshold value, a signal instructing to shift the corresponding equipment of the image processing apparatus to the standby state is output to the image processing apparatus. In this manner, by determining the use state of each equipment (the image reading equipment and the printing equipment) by all terminal apparatuses in the connected state separately for each of the working hours, the overtime hours and the non-working hours, even more finely grained power control is possible. For example, if the total value of the use frequency information of the image reading equipment for all terminal apparatuses in the connected state in the working hours is smaller than a threshold value set for the image reading equipment corresponding to the working hours, only the image reading equipment may be shifted to the standby state. Also, if the total value of the use frequency information of the printing equipment for all terminal apparatuses in the connected state in the working hours is smaller than a threshold value set for the printing equipment corresponding to the working hours, only the printing equipment may be shifted to the standby state.

With the image processing system of the present invention, a configuration may be adopted in which the table management unit manages the use frequency information, while collecting and updating, for each terminal apparatus, the use frequency information for an immediately preceding fixed period of time. Although the immediately preceding fixed period of time may be arbitrarily set, it may be set to one week, for example. In this manner, by constantly managing the use frequency information only for the immediately preceding fixed period of time, it becomes possible to perform shifting processing to the standby state, that is, power control, according to the latest use state of the image processing apparatus. Also, by managing the use frequency information only for the immediately preceding fixed period of time, the managed data size can be reduced.

With the image processing system of the present invention, a configuration may be adopted in which the control unit performs said processing every time the connection state of the terminal apparatuses to the communication line changes. The total value of the use frequency information changes when the connection state of the terminal apparatuses to the communication line has changed (that is, when an arbitrary terminal apparatus is disconnected from the communication line, or when a terminal apparatus has connected to the communication line), and thus by comparing again the total value of the use frequency information with the threshold value at this timing, it is possible to perform appropriate power control in accordance with the new connection state.

With the image processing system of the present invention, a configuration may be adopted in which the image processing apparatus has its own power saving mode in which, after a fixed period of time has passed after execution of the last job, the image processing apparatus shifts to the standby state, and while a signal instructing the image processing apparatus to maintain the operation state is being received from the management apparatus, its own power saving mode is not performed even if the fixed period of time has passed after the execution of the last job. Specifically, by giving priority to the instruction from the management apparatus, in the case where several terminal apparatuses are connected to the communication line and the total value of the use frequency information thereof exceeds the threshold value, for example, even if a fixed period of time has passed after execution of the last job, the operation state is maintained. In this manner it is possible to perform power control based on the current use state of the system.

Also, with the image processing system of the present invention, threshold value may be arbitrarily set by the user. The use state of the image processing apparatus differs depending on the size, the business form or the like of the company that employs the image processing system of the present invention. Therefore, when the threshold values can be arbitrarily set, the user (company staff) can set optimal threshold values according to the current conditions of the company, which makes it possible to perform the power control (power saving control) more effectively.

With the image processing system of the present invention, the time period may be arbitrarily set by the user. The working hours differs between companies, and also in the case of a factory or the like that operates 24 hours a day, the working hours and the non-working hours cannot be clearly distinguished. Therefore, letting the user (company staff) set the time periods makes it possible to build the image processing system suitable for the company.

Also, a management apparatus of the present invention is a management apparatus that manages the operation state of an image processing apparatus and a plurality of terminal apparatuses that are connected to each other via a communication line, the management apparatus including: a table management unit that collects, for each terminal apparatus, use frequency information of the image processing apparatus, and manages the collected use frequency information with a use frequency information management table; a monitoring unit that monitors the connection/non-connection state of each terminal apparatus to the image processing apparatus; a threshold value storage unit that stores a threshold value that serves as a determination criterion for shifting the image processing apparatus from an operation state to a standby state; and a control unit that controls the shifting of the image processing apparatus from the operation state to the standby state, using the use frequency information management table, the monitoring unit and the threshold value storage unit, wherein the control unit identifies terminal apparatuses that are connected to the image processing apparatus by the monitoring unit, and obtains the use frequency information for all terminal apparatuses that have been identified to be in the connected state from the use frequency information management table and adds the obtained use frequency information, and if a total value obtained by the addition is smaller than the threshold value stored in the threshold value storage unit, outputs a signal instructing the image processing apparatus to shift to the standby state to the image processing apparatus, and if the total value is larger than or equal to the threshold value, outputs a signal instructing the image processing apparatus to maintain the operation state to the image processing apparatus.

Specifically, as a result of the management apparatus performing overall management of the operation state of the image processing apparatus and a plurality of terminal apparatuses, it is sufficient if the image processing apparatus is operated according to the instruction signal sent from the management apparatus, and thus it is possible to reduce the burden on the image processing apparatus in the power control.

Also, an image processing apparatus of the present invention is an image processing apparatus to which a plurality of terminal apparatuses can be connected via a communication line, the image processing apparatus including: an image reading unit that scans a document and reads image data thereof; a storage unit that stores the read image data; a printing unit that prints image data accumulated in the storage unit or image data sent from a terminal apparatus; a table management unit that collects, for each terminal apparatus, the use frequency information of the image processing apparatus, and manages the collected use frequency information with a use frequency information management table; a monitoring unit that monitors the connection/non-connection state of each terminal apparatus to the image processing apparatus; a threshold value storage unit that stores a threshold value that serves as a determination criterion for shifting the image processing apparatus from an operation state to a standby state; and a control unit that controls the shifting of the image processing apparatus from the operation state to the standby state by using the use frequency information management table, the monitoring unit and the threshold value storage unit, wherein the control unit identifies terminal apparatuses that are connected to the image processing apparatus by the monitoring unit, and obtains the use frequency information for all terminal apparatuses that have been identified to be in the connected state from the use frequency information management table and adds the obtained use frequency information, and if a total value obtained by the addition is smaller than the threshold value stored in the threshold value storage unit, shifts the image processing apparatus to the standby state, and if the total value is larger than or equal to the threshold value, maintains the image processing apparatus in the operation state.

According to the image processing apparatus of the invention, the units for the operations necessary for the power control, such as management of the connection state of or the use frequency information for a plurality of terminal apparatuses, and comparison with the threshold value, are included in the image processing apparatus. Thus, a server apparatus for managing these units is not necessary.

Also, a power control method of an image processing apparatus of the present invention is a power control method for an image processing apparatus in a management apparatus that manages the operation state of an image processing apparatus and a plurality of terminal apparatuses that are connected to each other via a communication line, wherein the managing apparatus includes: a table management unit that collects, for each terminal apparatus, use frequency information of the image processing apparatus, and manages the collected use frequency information with a use frequency information management table; a monitoring unit that monitors the connection/non-connection state of each terminal apparatus to the communication line; a threshold value storage unit that stores a threshold value that serves as a determination criterion for shifting the image processing apparatus from an operation state to a standby state; and a control unit that controls the shifting of the image processing apparatus from the operation state to the standby state, using the use frequency information management table, the monitoring unit and the threshold value storage unit, and the control unit executes the steps of: identifying terminal apparatuses that are connected to the communication line by the monitoring unit; obtaining the use frequency information for all terminal apparatuses that have been identified to be in the connected state from the use frequency information management table and adding the obtained use frequency information; comparing a total value obtained by the addition with the threshold value stored in the threshold value storage unit; and as a result of the comparison, if the total value is smaller than the threshold value, outputting a signal instructing the image processing apparatus to shift to the standby state to the image processing apparatus; and as a result of the comparison, if the total value is larger than or equal to the threshold value, outputting a signal instructing the image processing apparatus to maintain the operation state to the image processing apparatus.

Also, a power control program of the present invention is a power control program of an image processing apparatus in an image processing system in which an image processing apparatus, a plurality of terminal apparatuses and a management apparatus that manages the operation state of the image processing apparatus and the terminal apparatuses are mutually connected via a communication line, the management apparatus including: a table management unit that collects, for each terminal apparatus, use frequency information of the image processing apparatus, and manages the collected use frequency information with a use frequency information management table; a monitoring unit that monitors the connection/non-connection state of each terminal apparatus to the communication line; a threshold value storage unit that stores a threshold value that serves as a determination criterion for shifting the image processing apparatus from an operation state to a standby state; and a control unit that controls the shifting of the image processing apparatus from the operation state to the standby state, using the use frequency information management table, the monitoring unit and the threshold value storage unit, the power control program being stored in a computer-readable recording medium and causing a computer serving as the control unit to execute the steps of: identifying terminal apparatuses that are connected to the communication line by the monitoring unit; obtaining the use frequency information for all terminal apparatuses that have been identified to be in the connected state from the use frequency information management table and adding the obtained use frequency information; comparing a total value obtained by the addition with the threshold value stored in the threshold value storage unit; and as a result of the comparison, if the total value is smaller than the threshold value, outputting a signal instructing the image processing apparatus to shift to the standby state to the image processing apparatus; and as a result of the comparison, if the total value is larger than or equal to the threshold value, outputting a signal instructing the image processing apparatus to maintain the operation state to the image processing apparatus.

In addition, a computer-readable recording medium in which this power control program is recorded is also included in the scope of the present invention.

With the power control method and the power control program of the present invention, the configuration is such that the image processing apparatus is shifted from the operation state to the standby state based on the total value of the use frequency information for all terminal apparatuses connected to the system, instead of the number of the terminal apparatuses connected to the system. Specifically, the configuration is such that the use frequency information is obtained for all terminal apparatus in the connected state from the use frequency information management table and the obtained use frequency information is added. If the total value obtained by the addition is smaller than the threshold value stored in the threshold value storage unit, a signal instructing to shift the image processing apparatus to the standby state is output to the image processing apparatus, thereby shifting the image processing apparatus from the operation state to the standby state. In this manner, since shifting to the standby state is determined based on the actual use frequency (the total value of the actual numbers of times of use) of the image processing apparatus instead of the number of connected apparatuses, once shifting to the standby state is made, the standby state is likely to continue for a while. Accordingly, the possibility that the return operation from the standby state is frequently performed, as in the conventional techniques, decreases. That is, it is possible to fully improve both a power saving effect and convenience for users who use the image processing apparatus.

### BRIEF DESCRIPTION OF THE DRAWINGS

FIG. 1 is a diagram schematically illustrating the overall configuration of an image processing system according to Embodiment 1 of the invention.

FIG. 2A is a diagram illustrating an example of the basic configuration of a use frequency information management table stored in a table management unit.

FIG. 2B is a diagram illustrating an example of the basic configuration of the use frequency information management table stored in the table management unit.

FIG. 2C is a diagram illustrating an example of the basic configuration of the use frequency information management table stored in the table management unit.

FIG. 2D is a diagram illustrating an example of the basic configuration of the use frequency information management table stored in the table management unit.

FIG. 3A is a diagram illustrating an example of the configuration of a working hour use frequency information management table.

FIG. 3B is a diagram illustrating an example of the configuration of an overtime hour use frequency information management table.

FIG. 3C is a diagram illustrating an example of the configuration of a non-working hour use frequency information management table.

FIG. 4A is a diagram illustrating an example of the configuration of a working hour threshold value storage table.

FIG. 4B is a diagram illustrating an example of the configuration of an overtime hour threshold value storage table.

FIG. 4C is a diagram illustrating an example of the configuration of a non-working hour threshold value storage table.

FIG. 5 is a flowchart illustrating the processing operation for power control of a digital multifunctional peripheral.

FIG. 6 is a diagram schematically illustrating the overall configuration of an image processing apparatus according to Embodiment 2 of the invention.

### DESCRIPTION OF THE PREFERRED EMBODIMENTS

Hereinafter, embodiments of the present invention will be described with reference to the accompanying drawings.

### Embodiment 1

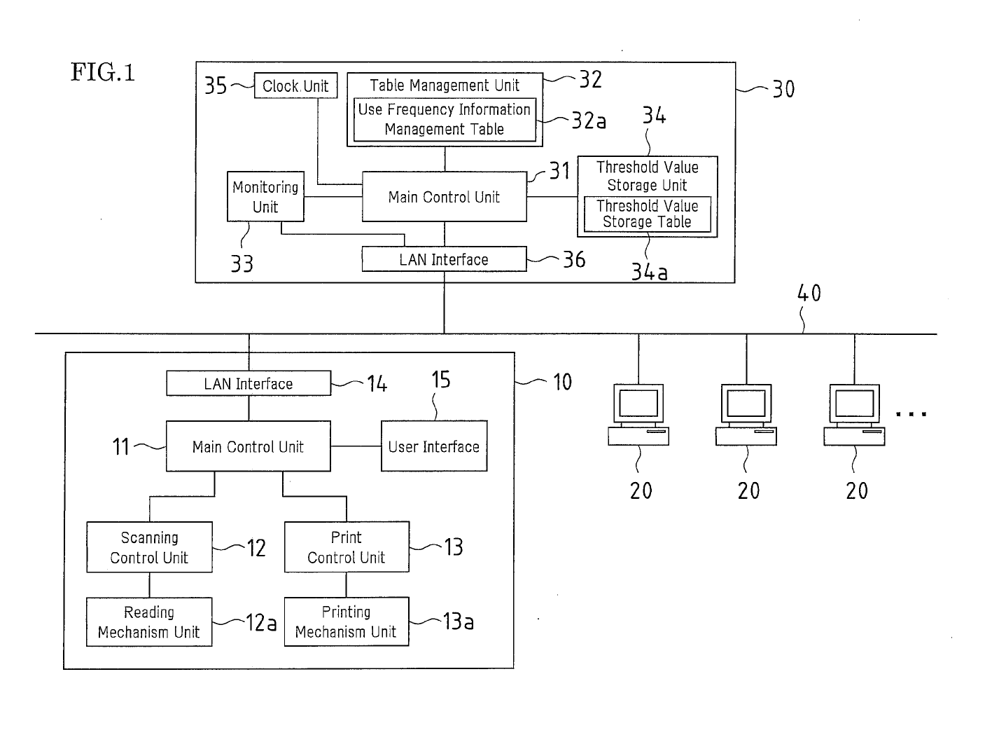

FIG. 1 is a diagram schematically illustrating the overall configuration of an image processing system according to Embodiment 1 of the invention.

In the image processing system of Embodiment 1, a digital multifunctional peripheral 10 serving as an image processing apparatus, a plurality of terminal apparatuses (personal computers) 20, and a management apparatus (hereinafter referred to as a “management server”) 30 that manages the operation states of the digital multifunctional peripheral 10 and the terminal apparatuses 20 are mutually connected via a communication line (network) 40.

The digital multifunctional peripheral 10 includes a scanning control unit (image reading unit) 12 that controls the operation of a reading mechanism unit (a CCD unit, an automatic document feeding device, etc.) 12a for scanning documents and reading image data thereof, a print control unit (printing unit) 13 that controls the operation of a printing mechanism unit (a paper feed unit, a transport unit, an image formation unit, a transfer unit, a fixing unit and the like) 13a for printing image data read through control of the scanning control unit 12 or image data sent from the terminal apparatuses 20, a LAN interface 14 for communicating with the terminal apparatuses 20 or the management server 30, a user interface 15 including an operation panel, not shown in the drawings, for receiving various operations by the user, and a main control unit 11 that controls the control units 12 and 13 and the interfaces 14 and 15. Note that the main control unit 11 includes a hard disk device, which is an assistant storage unit for temporarily accumulating image data to be processed, although not shown in the drawings.

The digital multifunctional peripheral 10 has a plurality of processing modes such as a scanning mode, a print mode and a copying mode. In the scanning mode, the digital multifunctional peripheral 10 causes only the scanning control unit 12 to operate, and in the print mode, it causes only the print control unit 13 to operate, and in the copying mode, it causes both the scanning control unit 12 and the print control unit 13 to operate.

The management server 30 has a function of monitoring use logs (the use state of the digital multifunctional peripheral 10, records of data communication or the like) of all the terminal apparatuses 20 connected to the network 40, and includes a table management unit 32 that collects the use frequency information of the digital multifunctional peripheral 10 for each terminal apparatus 20, and manages the use frequency information with a use frequency information management table 32a, a monitoring unit 33 that monitors the connection/non-connection state of each terminal apparatus 20 to the network 40, a threshold value storage unit 34 that stores a threshold value that serves as a determination criterion for shifting the digital multifunctional peripheral 10 from an operation state to a standby state, a clock unit 35 that measures the current time, a LAN interface 36 for communicating with the digital multifunctional peripheral 10 or the terminal apparatuses 20, and a main control unit 31 that controls the units 32, 33, 34 and 35 and the LAN interface 36.

The table management unit 32, through the control by the main control unit 31, collects use frequency information of the digital multifunctional peripheral 10 for each terminal apparatus 20 connected to the network 40, and writes the collected use frequency information in the use frequency information management table 32a from time to time, thereby managing the use frequency information. The use frequency information in this example refers to the number of times of use of the digital multifunctional peripheral 10, namely, the number of times of sending a job to the digital multifunctional peripheral 10.

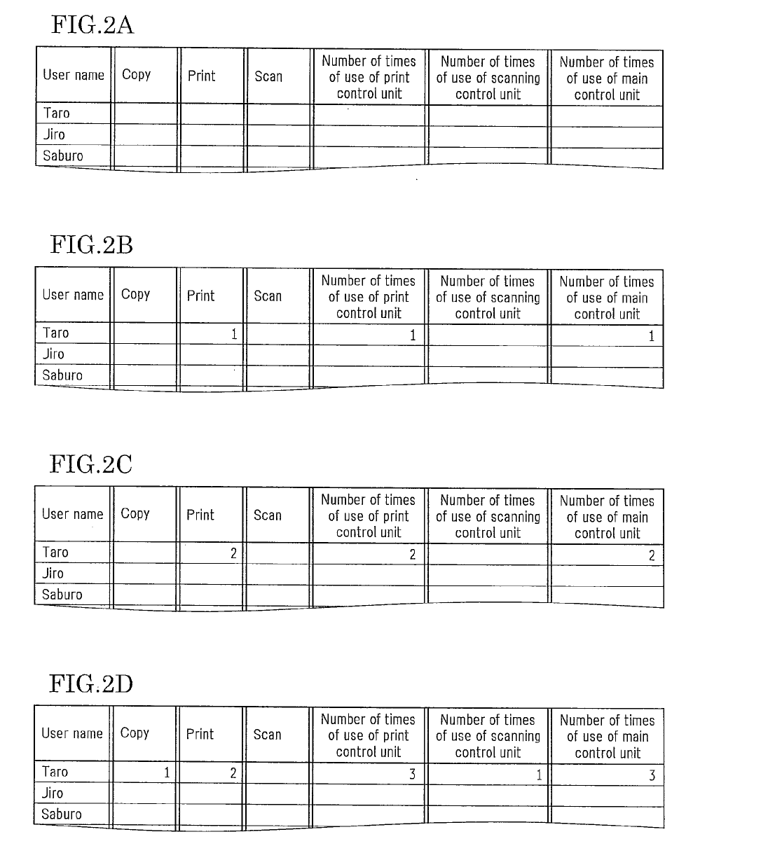

FIGS. 2A to 2D illustrate basic configuration examples of the use frequency information management table 32a stored in the table management unit 32.

As shown in FIG. 2A, the use frequency information management table 32a includes, as its items, all user names (precisely, ID numbers of the terminal apparatuses) that can connect to the network 40, processing modes of the digital multifunctional peripheral 10, which are “Copy mode”, “Print mode” and “Scan mode”, and “Number of times of use of print control unit”, “Number of times of use of scanning control unit”, and “Number of times of use of main control unit”.

The table management unit 32 manages the use state of the digital multifunctional peripheral 10 by each user (terminal apparatus) by using the use frequency information management table 32a.

For example, when the terminal apparatus 20 having the user name “Taro” has sent a print job once to the digital multifunctional peripheral 10, as shown in FIG. 2B, in the row of the user name “Taro”, “1” is written in the “Print” column, “1” is written in the “Number of times of use of print control unit” column, and “1” is written in the “Number of times of use of main control unit” column.

Thereafter, when the terminal apparatus 20 having the user name “Taro” again has sent a print job to the digital multifunctional peripheral 10, as shown in FIG. 2C, in the row of the user name “Taro”, the “Print” column is overwritten with “2” (“1” is overwritten with “2”), the “Number of times of use of print control unit” column is overwritten with “2” (“1” is overwritten with “2”), and the “Number of times of use of main control unit” column is overwritten with “2” (“1” is overwritten with “2”).

Next, when the terminal apparatuses 20 having the user name “Taro” has sent a copy job to the digital multifunctional peripheral 10, then, as shown in FIG. 2D, in the row of the user name “Taro”, “1” is written in the “Copy” column, the “Number of times of use of print control unit” column is overwritten with “3” (“2” is overwritten with “3”), and “1” is written in the “Number of times of use of scanning control unit” column, and the “Number of times of use of main control unit” column is overwritten with “3” (“2” is overwritten with “3”). Specifically, since both the print control unit 13 and the scanning control unit 12 are operated in the copy mode (copy job) as described above, the figures in the columns indicating the number of times of use of the units are respectively incremented by one.

In Embodiment 1, the use frequency information management table 32a managed in this manner has three tables, namely, a working hour use frequency information management table 32a1 that is used for working hours (9:00 to 17:00), an overtime hour use frequency information management table 32a2 that is used for overtime hours (17:01 to 24:00), and a non-working hour use frequency information management table 32a3 that is used for non-working hours (00:01 to 8:59, and all day of Sunday). That is, the use frequencies by the terminal apparatuses 20 are managed separately for three time periods, namely, the working hours, the overtime hours and the non-working hours.

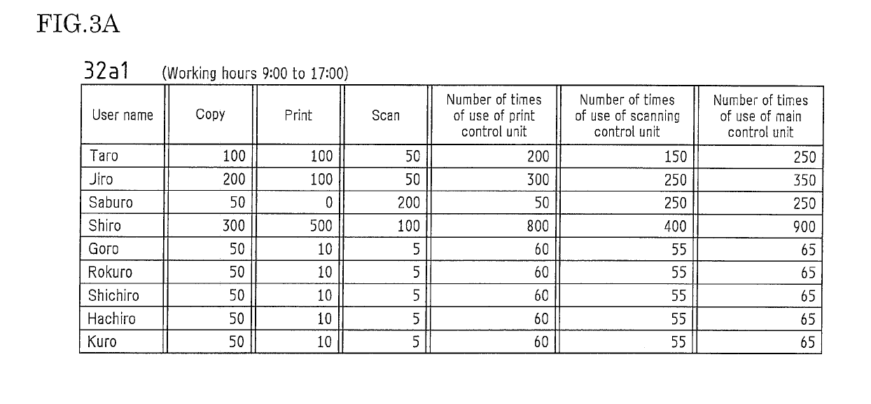

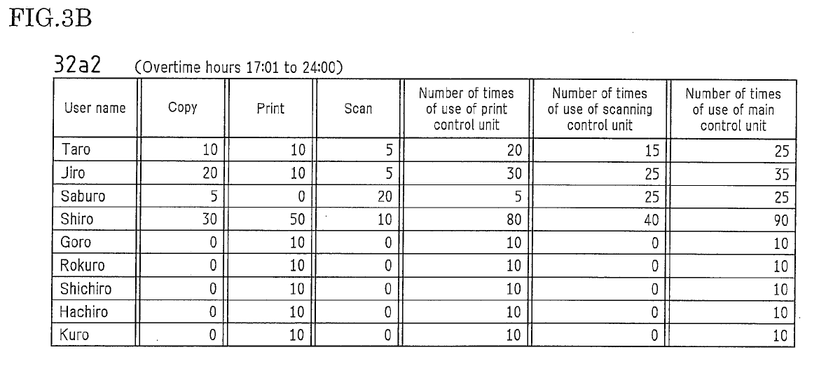

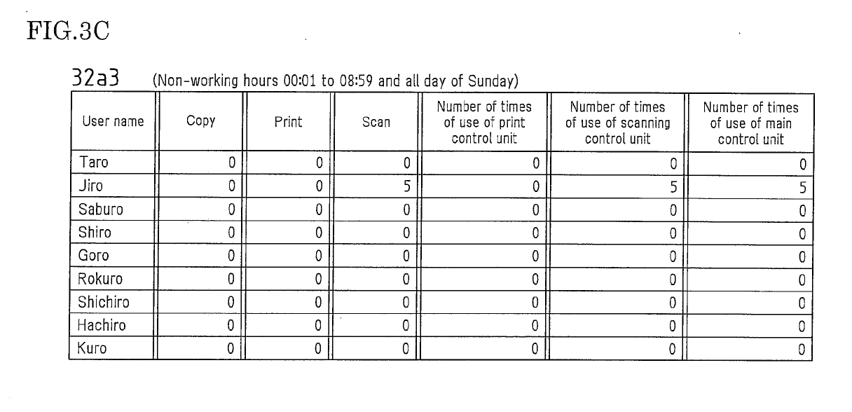

FIGS. 3A to 3C illustrates examples of the working hour use frequency information management table 32a1, the overtime hour use frequency information management table 32a2, and the non-working hour use frequency information management table 32a3.

Here, with reference to the use frequency information of the user name “Taro” in the working hour use frequency information management table 32a1 of FIG. 3A, it is described briefly how to understand this table.

In the use frequency information of the user name “Taro”, as regards processing modes, 100 copy jobs, 100 print jobs and 50 scanning jobs have been performed. As a result, in the “Number of times of use of print control unit” column, “200” is written as the number of times of use, which is obtained by adding 100 for copy jobs and 100 for print jobs. That is, since the print control unit 13 is used for copying and printing, the value “200” is obtained by adding the values for copying and printing.

Also, in the “Number of times of use of scanning control unit” column, “150” is written as the number of times of use that is obtained by adding 100 for copy jobs and 50 for scanning jobs. That is, since the scanning control unit 12 is used for copying and scanning, the value “150” is obtained by adding the values for copying and scanning.

Also, in the “Number of times of use of main control unit” column, “250” is written as the number of times of use that is obtained by adding 100 for copy jobs, 100 for print jobs and 50 for scanning jobs. That is, while the digital multifunctional peripheral 10 is powered on, the main control unit 11 is kept in a state waiting for jobs, and is used every time a job is received from the terminal apparatus 20. Thus, the number of times of use thereof is the value obtained by adding the values for all jobs.

In Embodiment 1, the table management unit 32 is configured such that the information on the number of times of use managed by the use frequency information management tables 32a1 to 32a3 is managed for each terminal apparatus 20, while collecting and updating the information for an immediately preceding fixed period of time. Although the immediately preceding fixed period of time can be set arbitrarily, it may be set to one week, for example. In this manner, by constantly managing the number of times of use (use frequency information) only for the immediately preceding fixed period of time, it becomes possible to perform a shift to the standby state, that is, power control, according to the latest use state of the digital multifunctional peripheral 10 (the immediately preceding one week).

The monitoring unit 33 monitors the connection/non-connection state of each terminal apparatus 20 to the network 40, that is, the log-in/log-out state, such as whether a terminal apparatus 20 has logged in to or logged out of the network 40.

The threshold value storage unit 34 includes a threshold value storage table 34a that stores a threshold value serving as a determination criterion for shifting the digital multifunctional peripheral 10 from an operation state to a standby state. Here, the operation state refers to a state in which immediate execution of a received job is possible. Also, the standby state corresponds to a so-called power saving mode, and refers to a state in which power supply to the control unit 12 or 13, or the main control unit 11 is stopped. In the standby state, it is possible to switch among plural steps of power saving modes depending on the unit to which power supply is stopped.

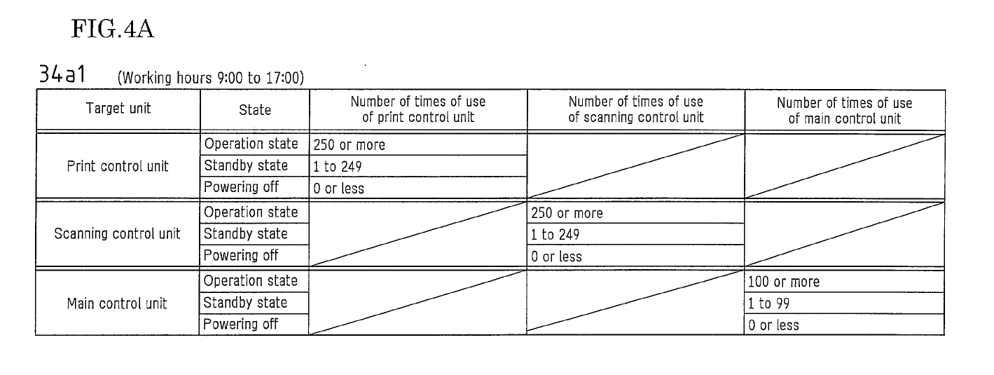

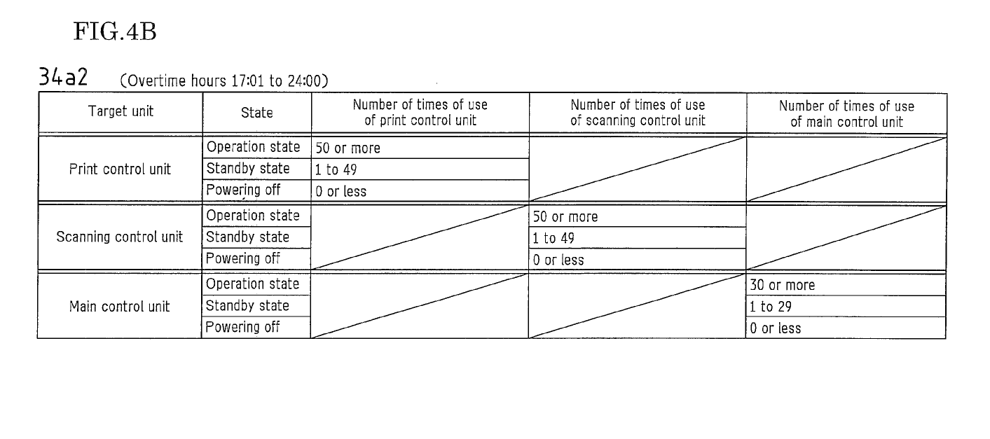

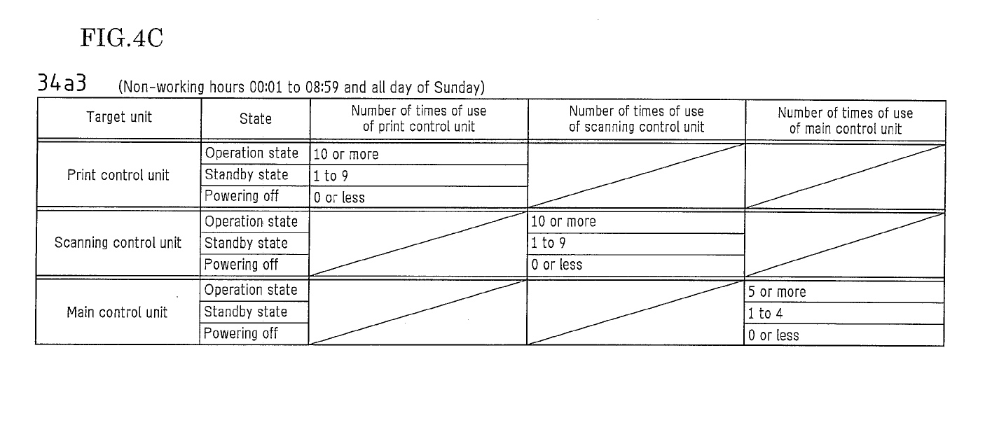

FIG. 4A to 4C illustrate configuration examples of the threshold value storage table 34a.

In this example, the threshold value storage table 34a has three tables, namely, a working hour threshold value storage table 34a1 that is used for working hours (9:00 to 17:00), an overtime hour threshold value storage table 34a2 that is used for overtime hours (17:01 to 24:00), and a non-working hour threshold value storage table 34a3 that is used for non-working hours (00:01 to 8:59 and all day of Sunday).

As illustrated in FIGS. 4A to 4C, the threshold value storage tables 34a1 to 34a3 each include the columns “Target unit”, “State”, “Number of times of use of print control unit”, “Number of times of use of scanning control unit”, and “Number of times of use of main control unit”. In the column “Target unit”, three units, namely, the print control unit, the scanning control unit and the main control unit, are listed as the target units. Also, in the “State” column, three states, namely, the operation state, the standby state, and the power-off state, are listed for each unit, and threshold values corresponding to each state are written (set) in the corresponding fields of the following items, which are “Number of times of use of print control unit”, “Number of times of use of scanning control unit”, and “Number of times of use of main control unit”.

For example, in the working hour threshold value storage table 34a1 shown in FIG. 4A, “250” is set in the “Number of times of use of print control unit” column as a threshold value for the case where the target unit is the print control unit. Specifically, shifting conditions are set such that the print control unit is shifted to the operation state if the number of times of use is 250 or more, to the standby state if the number of times of use is one to 249, and to the power-off state if the number of times of use is 0 or less.

Also, “250” is set in the “Number of times of use of scanning control unit” column as a threshold value for the case where the target unit is the scanning control unit. Specifically, shifting conditions are set such that the scanning control unit is shifted to the operation state if the number of times of use is 250 or more, to the standby state if the number of times of use is one to 249, and to the power-off state if the number of times of use is 0 or less.

Also, “100” is set in the “Number of times of use of main control unit” column as a threshold value for the case where the target unit is the main control unit. Specifically, shifting conditions are set such that the main control unit is shifted to the operation state if the number of times of use is 100 or more, to the standby state if the number of times of use is one to 99, and to the power-off state if the number of times of use is 0 or less.

Similarly, in the overtime hour threshold value storage table 34a2 and the non-working hour threshold value storage table 34a3 as well, appropriate values for the corresponding time periods are set as threshold values. Note that these figures are merely examples, and the present invention is not limited to these values.

Also, since the table management unit 32 manages the use frequency information (the number of times of use) by the terminal apparatuses 20 only for the immediately preceding one week, as described above, the threshold values may be set to optimal values based on the state of use by the terminal apparatuses for the immediately preceding one week.

Furthermore, these threshold values may be arbitrarily set by the user. The use state of the digital multifunctional peripheral 10 differs depending on the size, the business form or the like of the company that employs the image processing system of the present invention. Therefore, when the threshold values can be arbitrarily set, the user (company staff) can set optimal threshold values according to the current conditions of the company, which makes it possible to perform power control (power saving control) of the digital multifunctional peripheral 10 more effectively.

Similarly, the time periods may be arbitrarily set by the user. The working hours differs between companies, and also in the case of a factory or the like that operates 24 hours a day, the working hours and the non-working hours may not be clearly distinguished. Therefore, letting the user (company staff) set the time periods makes it possible to build an image processing system suitable for the company.

The main control unit 31 controls shifting of the digital multifunctional peripheral 10 from the operation state to the standby state by using the use frequency information management table 32a, the monitoring unit 33 and the threshold value storage table 34a. That is, the main control unit 31 identifies terminal apparatuses 20 that are connected to the network 40 by the monitoring unit 33, and obtains the numbers of times of use (the use frequency information) by all the terminal apparatuses 20 identified to be in the connected state from the use frequency information management table 32a, and adds the obtained numbers. If the total value obtained by the addition is smaller than the threshold value stored in the threshold value storage table 34a of the threshold value storage unit 34, a signal instructing to shift the digital multifunctional peripheral 10 to the standby state is output to the digital multifunctional peripheral 10, and if the total value is larger or equal to the threshold value, a signal instructing to maintain the digital multifunctional peripheral 10 in the operation state is output to the digital multifunctional peripheral 10.

If the main control unit 11 of the digital multifunctional peripheral 10 has received the signal instructing to shift to the standby state from the management server 30, it immediately shifts the digital multifunctional peripheral 10 from the operation state to the standby state (the power saving mode in which power supply to some or all units is stopped). On the other hand, if the main control unit 11 of the digital multifunctional peripheral 10 has received the signal instructing to maintain the operation state from the management server 30, it maintains the units of the digital multifunctional peripheral 10 in the operation state, regardless of the presence/absence of jobs from the terminal apparatuses 20. In this case, although the digital multifunctional peripheral 10 has its own power saving mode in which the digital multifunctional peripheral 10 is shifted to the standby state when a fixed period of time has passed after the execution of the last job, that power saving mode of the digital multifunctional peripheral 10 is not performed even if the fixed period of time has passed after the execution of the last job, while the signal instructing to maintain the operation state is being received from the management server 30. That is, by giving priority to the instruction from the management server 30, in the case where several terminal apparatuses 20 are connected to the network 40 and the total value of the numbers of times of use (the use frequency information) thereof is larger or equal to a threshold value, for example, the operation state is maintained even if the fixed period of time has passed after the execution of the last job. In this manner, it is possible to perform power control of the digital multifunctional peripheral 10 based on the operation state of the image processing system at that time.

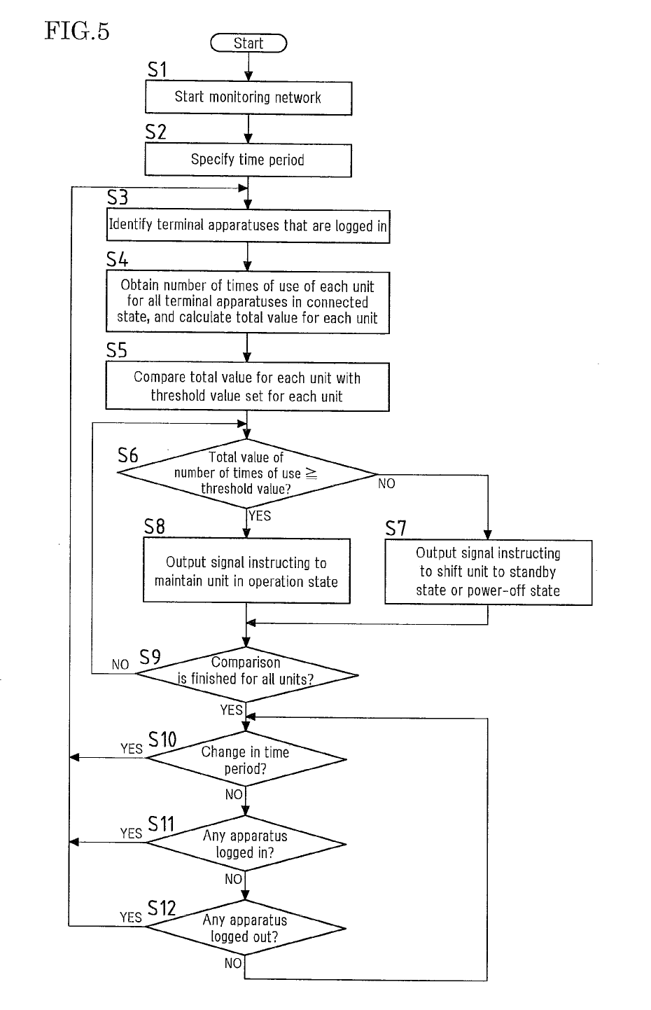

A specific example of the power control of the digital multifunctional peripheral 10 is described below with reference to FIGS. 3A to 3C, FIGS. 4A to 4C, and the flowchart shown in FIG. 5. Note that the numbers of times of use of the units by each terminal apparatus for the immediately preceding one week have been already entered in the use frequency information management tables 32a1 to 32a3, as shown in FIGS. 3A to 3C. Also, three specific examples of the power control will be described, that is, (1) specific example for working hours, (2) specific example for overtime hours and, (3) specific example for non-working hours.

(1) Specific example for working hours

The main control unit 31 of the management server 30 controls the monitoring unit 33 and starts monitoring the network 40 (step 51).

Specifically, the main control unit 31 obtains the current time from the clock unit 35 and specifies a time period that includes the current time (step S2). In this example, the current time is assumed to be ten o'clock in the morning (10:00) of a weekday, for example.

Next, the main control unit 31 identifies the terminal apparatuses 20 that are currently logged in to the network 40 (step S3). In this example, it is assumed that two terminal apparatuses 20, which are “Saburo” and “Goro”, are logged in.

Next, the main control unit 31 obtains the number of times of use of each unit by all the terminal apparatuses 20 that have been identified to be in the connected state in step S3 from the use frequency information management table 32a, and adds the numbers of times of use for each unit and obtains a total value thereof (step S4). At this time, the main control unit 31 calculates the total value of the numbers of times of use of each unit by the terminal apparatuses 20 from the use frequency information management table 32a that corresponds to the time period specified in step S2.

That is, since the current time is ten o'clock in the morning (10:00) of a weekday, the main control unit 31 calculates the total value of the numbers of times of use of each unit by “Saburo” and “Goro” from the working hour use frequency information management table 32a1 shown in FIG. 3A.

Specifically, since the number of times of use of the print control unit by “Saburo” is 50 and that by “Goro” is 60, these values are added, thereby obtaining the total value of 110. Also, since the number of times of use of the scanning control unit by “Saburo” is 250 and that by “Goro” is 55, these values are added, thereby obtaining the total value of 305. Also, since the number of times of use of the main control unit by “Saburo” is 250 and that by “Goro” is 65, these values are added, thereby obtaining the total value of 315.

Next, the main control unit 31 sequentially compares the total values of the numbers of times of use calculated for each unit with the threshold values that are set for each unit and stored in the working hour threshold value storage table 34a1 of the threshold value storage unit 34 (steps S6 to S9).

Specifically, 110, which is the total value of the numbers of times of use of the print control unit 13, is compared with 250, which is the threshold value set for the print control unit in the working hour threshold value storage table 34a1 (step S6). In this case, since the result is that the total value is smaller than the threshold value (total value<threshold value) (“No” in step S6), the main control unit 31 outputs a signal instructing the digital multifunctional peripheral 10 to shift the print control unit 13 to the standby state to the digital multifunctional peripheral 10 (step S7).

When the digital multifunctional peripheral 10 has received the signal instructing the shift to the standby state from the management server 30, it executes the power saving mode in which the print control unit 13 is immediately shifted to the standby state.

Next, the main control unit 31 compares 305, which is the total value of the numbers of times of use of the scanning control unit 12, with 250, which is the threshold value set for the scanning control unit in the working hour threshold value storage table 34a1 (step S6). In this case, since the result is that the total value is larger than the threshold value (total value>threshold value) (“Yes” in step S6), the main control unit 31 outputs a signal instructing the digital multifunctional peripheral 10 to maintain the scanning control unit 12 in the operation state to the digital multifunctional peripheral 10 (step S8).

When the digital multifunctional peripheral 10 has received the signal instructing maintaining of the operation state from the management server 30, it maintains the scanning control unit 12 in the operation state. Specifically, even if a fixed period of time has passed without receiving a job from the terminal apparatuses 20, no shift to the power saving mode that is originally set in the digital multifunctional peripheral 10 is made.

Next, the main control unit 31 compares 315, which is the total value of the numbers of times of use of the main control unit 31, with 100, which is the threshold value set for the main control unit in the working hour threshold value storage table 34a1 (step S6). In this case, since the result is that the total value is larger than the threshold value (total value>threshold value) (“Yes” in step S6), the main control unit 31 outputs a signal instructing the digital multifunctional peripheral 10 to maintain the main control unit 11 in the operation state to the digital multifunctional peripheral 10 (step S8).

When the digital multifunctional peripheral 10 has received the signal instructing maintaining of the operation state from the management server 30, it maintains the main control unit 11 in the operation state. Specifically, even if a fixed period of time has passed without receiving a job from the terminal apparatuses 20, no shift to the power saving mode that is originally set in the digital multifunctional peripheral 10 is made.

Specifically, the results of the comparison between the total value and the threshold value with respect to all units are that the print control unit 13 is set to the standby state, and the scanning control unit 12 and the main control unit 31 are set to the operation state.

When the comparison between the total value of the numbers of times of use and the threshold value is finished for all the units in this manner (“Yes” in step S9), then the main control unit 31 monitors whether there has been a change in the time period based on the current time obtained from the clock unit 35 (specifically, in this example, whether there has been a change from the working hours to the overtime hours) (step S10). If there has been no change, then it monitors whether any terminal apparatus 20 has logged in to the network (step S11), and whether any terminal apparatus 20 of the terminal apparatuses 20 in the connected state has logged out of the network (step S12). If there has been a change in the time period (“Yes” in step S10), a terminal apparatus 20 has logged in to the network (“Yes” in step S11), or a terminal apparatus 20 of the terminal apparatuses 20 in the connected state has logged out of the network (“Yes” in step S12), the processing returns to step S3, and the processing is repeated from the processing of identifying terminal apparatuses 20 that are currently logged in to the network.

Specifically, as a result of a terminal apparatus 20 being logged in and logged out, the total value of the numbers of times of use by all the terminal apparatuses 20 in the connected state changes. By re-calculating the total value of the numbers of times of use at this timing of log-in and log-out, it is possible to perform appropriate power control in accordance with the new connection state.

Note that the power control processing in steps S1 to S12 ends when the digital multifunctional peripheral 10 is powered off.

(2) Specific example for overtime hours

The main control unit 31 of the management server 30 controls the monitoring unit 33, and starts monitoring the network 40 (step S1).

Specifically, the main control unit 31 obtains the current time from the clock unit 35 and specifies a time period that includes the current time (step S2). In this example, the current time is assumed to be ten o'clock in the evening (22:00) of a weekday, for example

Next, the main control unit 31 identifies the terminal apparatuses 20 that are currently logged in to the network 40 (step S3). In this example, it is assumed that five terminal apparatuses 20, namely “Goro”, “Rokuro”, “Shichiro”, “Hachiro” and “Kuro”, are logged in.

Next, the main control unit 31 obtains the number of times of use of each unit by all the terminal apparatuses 20 that have been identified to be in the connected state in step S3 from the use frequency information management table 32a, and adds the numbers of times of use for each unit and obtains a total value thereof (step S4). At this time, the main control unit 31 calculates the total value of the numbers of times of use of each unit by the terminal apparatuses 20 from the use frequency information management table 32a that corresponds to the time period specified in step S2.

That is, since the current time is ten o'clock in the evening (22:00) of a weekday, the main control unit 31 calculates the total value of the numbers of times of use of each unit by “Goro”, “Rokuro”, “Shichiro”, “Hachiro” and “Kuro” from the overtime hour use frequency information management table 32a2 shown in FIG. 3B.

Specifically, since the number of times of use of the print control unit by each of “Goro”, “Rokuro”, “Shichiro”, “Hachiro”, and “Kuro” is 10, these values are added, thereby obtaining the total value of 50. Also, since the number of times of use of the scanning control unit by each of “Goro”, “Rokuro”, “Shichiro”, “Hachiro”, and “Kuro” is 0, the total value is 0. Also, since the number of times of use of the main control unit by each of “Goro”,

“Rokuro”, “Shichiro”, “Hachiro”, and “Kuro” is 10, these values are added, thereby obtaining the total value of 50.

Next, the main control unit 31 sequentially compares the total values of the numbers of times of use calculated for each unit with the threshold values that are set for each unit and stored in the overtime hour threshold value storage table 34a2 of the threshold value storage unit 34 (steps S6 to S9).

Specifically, 50, which is the total value of the numbers of times of use of the print control unit 13 is compared with 50, which is the threshold value set for the print control unit in the overtime hour threshold value storage table 34a2 (step S6). In this case, since the result is that the total value is equal to the threshold value (total value=threshold value) (“Yes” in step S6), the main control unit 31 outputs a signal instructing the digital multifunctional peripheral 10 to maintain the scanning control unit 12 in the operation state to the digital multifunctional peripheral 10 (step S8).

When the digital multifunctional peripheral 10 has received the signal instructing maintaining of the operation state from the management server 30, it maintains the scanning control unit 12 in the operation state. Specifically, even if a fixed period of time has passed without receiving a job from the terminal apparatuses 20, no shift to the power saving mode that is originally set in the digital multifunctional peripheral 10 is made.

Next, the main control unit 31 compares 0, which is the total value of the numbers of times of use of the scanning control unit 12, with 50, which is the threshold value set for the scanning control unit in the overtime hour threshold value storage table 34a2 (step S6). In this case, since the result is that the total value is smaller than the threshold value (total value <threshold value), the determination made in step S6 is “Yes”. In this case, the total value is 0, which corresponds to the threshold value (0 or less) for powering off that is set for the scanning control unit in the overtime hour threshold value storage table 34a2, and thus the main control unit 31 outputs a signal instructing the digital multifunctional peripheral 10 to power off the scanning control unit 12 to the digital multifunctional peripheral 10 (step S7).

When the digital multifunctional peripheral 10 has received the signal instructing powering off from the management server 30, it executes the power saving mode in which the scanning control unit 12 is immediately shifted to the power-off state.

Next, the main control unit 31 compares 50, which is the total value of the numbers of times of use of the main control unit 31, with 30, which is the threshold value set for the main control unit in the overtime hour threshold value storage table 34a2 (step S6). In this case, since the result is that the total value is larger than the threshold value (total value>threshold value) (“Yes” in step S6), the main control unit 31 outputs a signal instructing the digital multifunctional peripheral 10 to maintain the main control unit 11 in the operation state to the digital multifunctional peripheral 10 (step S8).

When the digital multifunctional peripheral 10 has received the signal instructing maintaining of the operation state from the management server 30, it maintains the main control unit 11 in the operation state. Specifically, even if a fixed period of time has passed without receiving a job from the terminal apparatuses 20, no shift to the power saving mode that is originally set in the digital multifunctional peripheral 10 is made.

Specifically, the results of the comparison between the total value and the threshold value with respect to all units are that the print control unit 13 is set to the operation state, the scanning control unit 12 is set to the power-off state, and the main control unit 31 is set to the operation state.

When the comparison between the total value of the numbers of times of use and the threshold value is finished for all the units in this manner (“Yes” in step S9), then the main control unit 31 monitors whether there has been a change in the time period based on the current time obtained from the clock unit 35 (specifically, in this example, whether there has been a change from overtime hours to working hours, or from overtime hours to non-working hours) (step S10). If there has been no change, then it monitors whether any terminal apparatus 20 has logged in to the network (step S11), and whether any terminal apparatus 20 of the terminal apparatuses 20 in the connected state has logged out of the network (step S12). Then, if there has been a change in the time period (“Yes” in step S10), a terminal apparatus 20 has logged in to the network (“Yes” in step S11), or a terminal apparatus 20 of the terminal apparatuses 20 in the connected state has logged out of the network (“Yes” in step S12), the processing returns to step S3, and the processing is repeated from the processing of identifying terminal apparatuses 20 that are currently logged in to the network.

Note that the power control processing in steps S1 to S12 ends when the digital multifunctional peripheral 10 is powered off.

(3) Specific example for non-working hours

The main control unit 31 of the management server 30 controls the monitoring unit 33 and starts monitoring the network 40 (step S1).

Specifically, the main control unit 31 obtains the current time from the clock unit 35 and specifies a time period that includes the current time (step S2). In this example, the current time is assumed to be twelve o'clock (12:00) on a Sunday morning, for example.

Next, the main control unit 31 identifies the terminal apparatuses 20 that are currently logged in to the network 40 (step S3). In this example, it is assumed that two terminal apparatuses 20, which are “Jiro” and “Saburo”, are logged in.

Next, the main control unit 31 obtains the number of times of use of each unit by all the terminal apparatuses 20 that have been identified to be in the connected state in step S3 from the use frequency information management table 32a, and adds the numbers of times of use for each unit and obtains a total value thereof (step S4). At this time, the main control unit 31 calculates the total value of the numbers of times of use of each unit by the terminal apparatuses 20 from the use frequency information management table 32a that corresponds to the time period specified in step S2.

That is, since the current time is twelve o'clock (12:00) on a Sunday morning, the main control unit 31 calculates the total value of the numbers of times of use of each unit by “Jiro” and “Saburo” from the non-working hour use frequency information management table 32a3 shown in FIG. 3C.

Specifically, since the number of times of use of the print control unit by “Jiro” is 0 and that by “Saburo” is also 0, these values are added, thereby obtaining the total value of 0. Also, since the number of times of use of the scanning control unit by “Jiro” is 5 and that by “Saburo” is 0, these values are added, thereby obtaining the total value of 5. Also, since the number of times of use of the main control unit by “Jiro” is 5 and that by “Saburo” is 0, these values are added, thereby obtaining the total value of 5.

Next, the main control unit 31 sequentially compares the total values of the numbers of times of use calculated for each unit with the threshold values that are set for each unit and stored in the non-working hour threshold value storage table 34a3 of the threshold value storage unit 34 (steps S6 to S9).

Specifically, which is the total value of the numbers of times of use of the print control unit 13, is compared with 10, which is the threshold value set for the print control unit in the non-working hour threshold value storage table 34a3 (step S6). In this case, since the result is that the total value is smaller than the threshold value (total value<threshold value), the determination made in step S6 is “No”. In this case, the total value is 0, which corresponds to the threshold value (0 or less) for powering off that is set for the print control unit in the non-working hour threshold value storage table 34a3, and thus the main control unit 31 outputs a signal instructing the digital multifunctional peripheral 10 to power off the print control unit 13 to the digital multifunctional peripheral 10 (step S7).

When the digital multifunctional peripheral 10 has received the signal instructing powering off from the management server 30, it executes the power saving mode in which the print control unit 13 is immediately shifted to the power-off state.

Next, the main control unit 31 compares 5, which is the total value of the numbers of times of use of the scanning control unit 12, with 10, which is the threshold value set for the scanning control unit in the non-working hour threshold value storage table 34a3 (step S6). In this case, since the result is that the total value is smaller than the threshold value (total value <threshold value) (“No” in step S6), the main control unit 31 outputs a signal instructing the digital multifunctional peripheral 10 to shift the scanning control unit 12 to the standby state to the digital multifunctional peripheral 10 (step S7).

When the digital multifunctional peripheral 10 has received the signal instructing the shift to the standby state from the management server 30, it shifts the scanning control unit 12 to the standby state.

Next, the main control unit 31 compares 5, which is the total value of the numbers of times of use of the main control unit 31, with 5, which is the threshold value set for the main control unit in the non-working hour threshold value storage table 34a3 (step S6). In this case, since the result is that the total value is equal to the threshold value (total value =threshold value) (“Yes” in step S6), the main control unit 31 outputs a signal instructing the digital multifunctional peripheral 10 to maintain the main control unit 11 in the operation state to the digital multifunctional peripheral 10 (step S8).

When the digital multifunctional peripheral 10 has received the signal instructing maintaining of the operation state from the management server 30, it maintains the main control unit 11 in the operation state. Specifically, even if a fixed period of time has passed without receiving a job from the terminal apparatuses 20, no shift to the power saving mode that is originally set in the digital multifunctional peripheral 10 is made.

Specifically, the results of the comparison between the total value and the threshold value with respect to all units are that the print control unit 13 is set to the power-off state, the scanning control unit 12 is set to the standby state, and the main control unit 31 is set to the operation state.

When the comparison between the total value of the numbers of times of use and the threshold value is finished for all the units in this manner (“Yes” in step S9), then the main control unit 31 monitors whether there has been a change in the time period based on the current time obtained from the clock unit 35 (specifically, in this example, whether there has been a change from non-working hours to working hours) (step S10). If there has been no change, then it monitors whether any terminal apparatus 20 has logged in to the network (step S11), and whether any terminal apparatus 20 of the terminal apparatuses 20 in the connected state has logged out of the network (step S12). Then, if there has been a change in the time period (“Yes” in step S10), a terminal apparatus 20 has logged in to the network (“Yes” in step S11), or a terminal apparatus 20 of the terminal apparatuses 20 in the connected state has logged out of the network (“Yes” in step S12), the processing returns to step S3, and repeats the processing from the processing of identifying terminal apparatuses 20 that are currently logged in to the network.

Note that the power control processing in steps S1 to S12 ends when the digital multifunctional peripheral 10 is powered off.

Note that in Embodiment 1, although the configuration is such that the number of times of use and the threshold value are compared for each time period and each unit, and shifting from the operation state to the standby state or the power-off state is controlled for each time period and each unit, with respect to the time period, there is no limitation to division into a plurality of the time periods as described above. For example, if the image processing system of the present invention is used only for working hours, it is sufficient that the table management unit 32 stores only the working hour use frequency management table 32a1, and the threshold value storage unit 34 stores only the working hour threshold value storage table 34a1, and with respect to the specific example of the power control, only the specific example (1) for working hours is performed.

Also, the power control may be performed such that the entire digital multifunctional peripheral 10 is shifted from the operation state to the standby state or the power-off state, instead of performing the power control separately for the main control unit 11, the scanning control unit 12 and the print control unit 13. In this case, if the image processing system of the present invention is used only for working hours, it is sufficient that the table management unit 32 stores only the working hour use frequency management table 32a1, the threshold value storage unit 34 stores only the working hour threshold value storage table 34a1. In the specific example of the power control, power control may be performed such that the number of times of use is compared with the threshold value with respect to the main control unit, focusing only on the “Number of times of use of main control unit” column in the working hour use frequency management table 32a1 and the “Number of times of use of main control unit” column in the working hour threshold value storage table 34a1, and the entire digital multifunctional peripheral 10 is shifted from the operation state to the standby state or the power-off state based on the comparison result.

### Embodiment 2

Although Embodiment 1 is configured such that the management server 30 manages the power control of the digital multifunctional peripheral 10, in Embodiment 2, the digital multifunctional peripheral 10 itself manages its power control. For this purpose, in Embodiment 2, main constituent elements of the management server 30 are included in the digital multifunctional peripheral 10, and as a result, the configuration of Embodiment 2 does not include the management server 30 in the network 40.

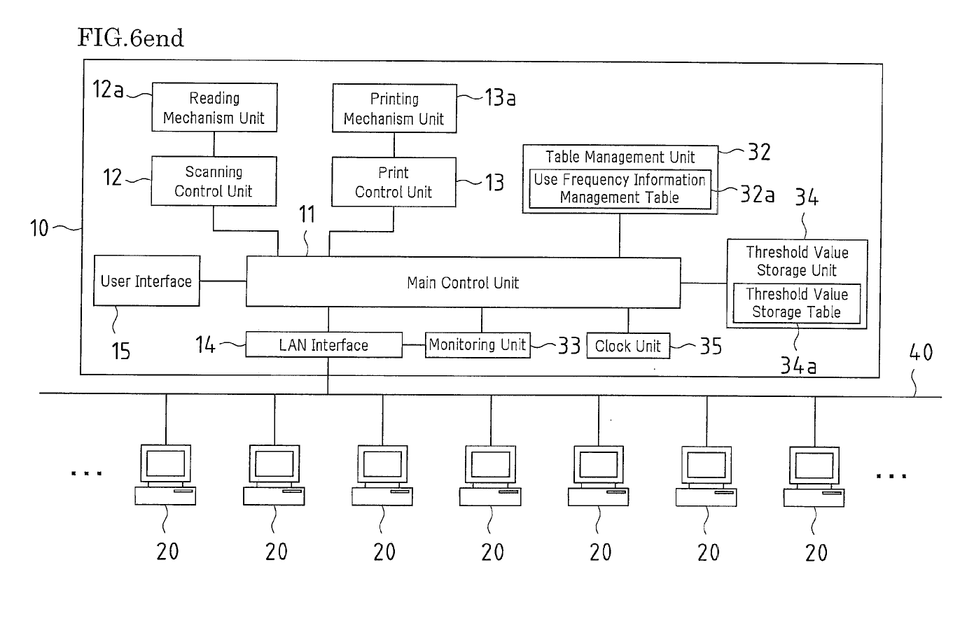

FIG. 6 schematically illustrates an overall configuration of the digital multifunctional peripheral 10, which is an image processing apparatus of Embodiment 2 of the present invention.

The digital multifunctional peripheral 10 of Embodiment 2 has, in addition to the configuration shown in FIG. 1, a function of monitoring the use logs of all terminal apparatuses 20 connected to the network 40, and includes a table management unit 32 that collects use frequency information of the digital multifunctional peripheral 10 for each terminal apparatus 20, and manages the use frequency information with a use frequency information management table 32a, a monitoring unit 33 that monitors the connection/non-connection state of each terminal apparatus 20 to the network 40, a threshold value storage unit 34 that stores a threshold value that serves as a determination criterion for shifting the digital multifunctional peripheral 10 from the operation state to the standby state, and a clock unit 35 that measures a current time, and the main control unit 11 that controls these units 32, 33, 34 and 35.

With such a configuration, it is possible to remove the management server 30 of Embodiment 1. Note that the power control method for the digital multifunctional peripheral 10 of Embodiment 2 is the same as that described in Embodiment 1, and thus specific description thereof is omitted here.

Note that the present invention can be implemented by a computer-readable recording medium in which a program executed by a computer is recorded, the program being a power control program for causing each step of the power control method described above to be executed.

As the recording medium, since the processing is executed by a computer, a memory, not shown in the drawings, such as a ROM may serve as a program medium, or the program medium may be a medium that can be read as a result of being inserted into a program reading device that is provided as an external storage device, although not shown. In any case, stored program code may be configured to be executed as a result of being accessed by a microprocessor. Alternatively, in any case, the program code may be read out, and the read-out program code may be downloaded to a program storage area, not shown in the drawings, of the microcomputer, and executed. This program for downloading is stored in advance in the apparatus main body.

Here, the program medium is a recording medium configured to be separable from the main body, and may be a tape, such as a magnetic tape, cassette tape and the like, a disk, for example a magnetic disk, such as a floppy (registered trademark) disk or a hard disk, or an optical disk, such as a CD-ROM, MO, MD, DVD and the like, a card, such as an IC card (including a memory card), an optical card and the like, or a medium that fixedly carries program code, including semiconductor memories such as a mask ROM, an EEPROM (Erasable Programmable Read Only Memory), an EEPROM (Electrically Erasable Programmable Read Only Memory), a flash ROM.

Also, in the case of a system configuration capable of connecting to a communication network including the Internet, a medium may be used that dynamically carries program code so as to download the program code from the communication network. Note that when program code is downloaded from the communication network in this manner, the program for downloading may be stored in advance in the apparatus main body, or may be installed from a separate recording medium.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the range of equivalency of the claims are intended to be embraced therein.

What is claimed is:

1. An image processing system in which an image processing apparatus, a plurality of terminal apparatuses, and a management apparatus that manages the operation state of the image processing apparatus and the terminal apparatuses are mutually connected via a communication line,
wherein the management apparatus comprises:
a table management unit that collects, for each terminal apparatus, use frequency information of the image processing apparatus, and manages the collected use frequency information with a use frequency information management table;
a monitoring unit that monitors the connection/non-connection state of each terminal apparatus to the communication line;
a threshold value storage unit that stores a threshold value that serves as a determination criterion for shifting the image processing apparatus from an operation state to a standby state; and
a control unit that controls the shifting of the image processing apparatus from the operation state to the standby state, using the use frequency information management table, the monitoring unit and the threshold value storage unit, and
the control unit identifies terminal apparatuses that are connected to the communication line by the monitoring unit, and obtains the use frequency information for all terminal apparatuses that have been identified to be in the connected state from the use frequency information management table and adds the obtained use frequency information, and if a total value obtained by the addition is smaller than the threshold value stored in the threshold value storage unit, outputs a signal instructing the image processing apparatus to shift to the standby state to the image processing apparatus, and if the total value is larger than or equal to the threshold value, outputs a signal instructing the image processing apparatus to maintain the operation state to the image processing apparatus.

2. The image processing system according to claim 1,
wherein in the case where the image processing apparatus has received the signal instructing it to shift to the standby state from the management apparatus, the image processing apparatus shifts from the operation state to the standby state, and in the case where the image processing apparatus has received the signal instructing it to maintain the operation state from the management apparatus, the image processing apparatus maintains the operation state.

3. The image processing system according to claim 1,
wherein the use frequency information is information on the number of times of use of the image processing apparatus.

4. The image processing system according to claim 2,
wherein the use frequency information is information on the number of times of use of the image processing apparatus.

5. The image processing system according to claim 1,
further comprising a clock unit that measures a current time,
wherein the table management unit collects, for each terminal apparatus, the use frequency information of the image processing apparatus, and manages the collected use frequency information with the use frequency information management table, for each of a plurality of time periods that have been set in advance,
the threshold value storage unit stores a threshold value for each of the time periods that have been set in advance,
the control unit obtains the use frequency information in a time period that includes the current time measured by the clock unit for all terminal apparatuses in the connected state from the use frequency information management table and adds the obtained use frequency information, and if a total value obtained by the addition is smaller than a threshold value that is set for that time period and stored in the threshold value storage unit, outputs a signal instructing the image processing apparatus to shift to the standby state to the image processing apparatus, and if the total value is larger than or equal to the threshold value, outputs a signal instructing the image processing apparatus to maintain the operation state to the image processing apparatus.

6. The image processing system according to claim 5,
wherein the plurality of time periods are three time periods, namely, working hours, overtime hours and non-working hours.

7. The image processing system according to claim 1,
wherein the image processing apparatus includes a scanning mode in which an image reading equipment that scans a document and reads image data thereof is operated, a print mode in which a printing equipment that prints the image data read by the image reading equipment or image data sent from a terminal apparatus is operated, and a copy mode in which the image reading equipment and the printing equipment are operated,
the table management unit collects, for each terminal apparatus, the use frequency information of each equipment, and manages the collected use frequency information with the use frequency information management table,
the threshold value storage unit stores a threshold value corresponding to the image reading equipment and a threshold value corresponding to the printing equipment, and
the control unit obtains the use frequency information of each equipment for all terminal apparatuses in the connected state from the use frequency information management table, adds the obtained the use frequency information for each equipment, and compares, for each equipment, the total value obtained by the addition with a threshold value set for the corresponding equipment and stored in the threshold value storage unit, and if the total value is smaller than the threshold value, outputs a signal instructing the corresponding equipment of the image processing apparatus to shift to the standby state to the image processing apparatus, and if the total value is larger than or equal to the threshold value, outputs a signal instructing the corresponding equipment of the image processing apparatus to maintain the operation state to the image processing apparatus.

8. The image processing system according to claim 5,
wherein the image processing apparatus includes a scanning mode in which an image reading equipment that scans a document and reads image data thereof is operated, a print mode in which a printing equipment that prints the image data read by the image reading equipment or image data sent from a terminal apparatus is operated, and a copy mode in which the image reading equipment and the printing equipment are operated,
the table management unit collects, for each terminal apparatus, the use frequency information of each equipment of the image processing apparatus in each time period, and manages the collected use frequency information with the use frequency information management table,
the threshold value storage unit stores, for each time period, a threshold value corresponding to the image reading equipment and a threshold value corresponding to the printing equipment, and
the control unit obtains the use frequency information of each equipment in a time period that includes the current time measured by the clock unit for all terminal apparatuses in the connected state from the use frequency information management table, adds the obtained use frequency information for each equipment, and compares, for each equipment, the total value obtained by the addition with a threshold value set for the corresponding equipment and the corresponding time period and stored in the threshold value storage unit, and if the total value is smaller than the threshold value, outputs a signal instructing the corresponding equipment of the image processing apparatus to shift to the standby state to the image processing apparatus, and if the total value is larger than or equal to the threshold value, outputs a signal instructing the corresponding equipment of the image processing apparatus to maintain the operation state to the image processing apparatus.

9. The image processing system according to claim 1,
wherein the table management unit manages the use frequency information, while collecting and updating, for each terminal apparatus, the use frequency information for an immediately preceding fixed period of time.

10. The image processing system according to claim 1,
wherein the control unit performs said processing every time the connection state of the terminal apparatuses to the communication line changes.

11. The image processing system according to claim 1,
wherein the image processing apparatus has its own power saving mode in which, after a fixed period of time has passed after execution of the last job, the image processing apparatus shifts to the standby state, and
while a signal instructing the image processing apparatus to maintain the operation state is being received from the management apparatus, its own power saving mode is not performed even if the fixed period of time has passed after the execution of the last job.

12. The image processing system according to claim 1,
wherein the threshold value can be arbitrarily set by the user.

13. The image processing system according to claim 5,
wherein the time period can be arbitrarily set by the user.

14. A management apparatus that manages the operation state of an image processing apparatus and a plurality of terminal apparatuses that are connected to each other via a communication line, the management apparatus comprising:
a table management unit that collects, for each terminal apparatus, use frequency information of the image processing apparatus, and manages the collected use frequency information with a use frequency information management table;
a monitoring unit that monitors the connection/non-connection state of each terminal apparatus to the image processing apparatus;
a threshold value storage unit that stores a threshold value that serves as a determination criterion for shifting the image processing apparatus from an operation state to a standby state; and
a control unit that controls the shifting of the image processing apparatus from the operation state to the standby state, using the use frequency information management table, the monitoring unit and the threshold value storage unit,
wherein the control unit identifies terminal apparatuses that are connected to the image processing apparatus by the monitoring unit, and obtains the use frequency information for all terminal apparatuses that have been identified to be in the connected state from the use frequency information management table and adds the obtained use frequency information, and if a total value obtained by the addition is smaller than the threshold value stored in the threshold value storage unit, outputs a signal instructing the image processing apparatus to shift to the standby state to the image processing apparatus, and if the total value is larger than or equal to the threshold value, outputs a signal instructing the image processing apparatus to maintain the operation state to the image processing apparatus.

15. An image processing apparatus to which a plurality of terminal apparatuses can be connected via a communication line, the image processing apparatus comprising:
an image reading unit that scans a document and reads image data thereof;
a storage unit that stores the read image data;
a printing unit that prints image data accumulated in the storage unit or image data sent from a terminal apparatus;
a table management unit that collects, for each terminal apparatus, the use frequency information of the image processing apparatus, and manages the collected use frequency information with a use frequency information management table;
a monitoring unit that monitors the connection/non-connection state of each terminal apparatus to the image processing apparatus;
a threshold value storage unit that stores a threshold value that serves as a determination criterion for shifting the image processing apparatus from an operation state to a standby state; and
a control unit that controls the shifting of the image processing apparatus from the operation state to the standby state by using the use frequency information management table, the monitoring unit and the threshold value storage unit,
wherein the control unit identifies terminal apparatuses that are connected to the image processing apparatus by the monitoring unit, and obtains the use frequency information for all terminal apparatuses that have been identified to be in the connected state from the use frequency information management table and adds the obtained use frequency information, and if a total value obtained by the addition is smaller than the threshold value stored in the threshold value storage unit, shifts the image processing apparatus to the standby state, and if the total value is larger than or equal to the threshold value, maintains the image processing apparatus in the operation state.

16. A power control method for an image processing apparatus in a management apparatus that manages the operation state of an image processing apparatus and a plurality of terminal apparatuses that are connected to each other via a communication line,
wherein the managing apparatus comprises: a table management unit that collects, for each terminal apparatus, use frequency information of the image processing apparatus, and manages the collected use frequency information with a use frequency information management table; a monitoring unit that monitors the connection/non-connection state of each terminal apparatus to the communication line; a threshold value storage unit that stores a threshold value that serves as a determination criterion for shifting the image processing apparatus from an operation state to a standby state; and a control unit that controls the shifting of the image processing apparatus from the operation state to the standby state, using the use frequency information management table, the monitoring unit and the threshold value storage unit, and
the control unit executes the steps of:
identifying terminal apparatuses that are connected to the communication line by the monitoring unit;
obtaining the use frequency information for all terminal apparatuses that have been identified to be in the connected state from the use frequency information management table and adding the obtained use frequency information;
comparing a total value obtained by the addition with the threshold value stored in the threshold value storage unit; and
as a result of the comparison, if the total value is smaller than the threshold value, outputting a signal instructing the image processing apparatus to shift to the standby state to the image processing apparatus; and
as a result of the comparison, if the total value is larger than or equal to the threshold value, outputting a signal instructing the image processing apparatus to maintain the operation state to the image processing apparatus.

17. A power control program of an image processing apparatus in an image processing system in which an image processing apparatus, a plurality of terminal apparatuses and a management apparatus that manages the operation state of the image processing apparatus and the terminal apparatuses are mutually connected via a communication line, the management apparatus comprising: a table management unit that collects, for each terminal apparatus, use frequency information of the image processing apparatus, and manages the collected use frequency information with a use frequency information management table; a monitoring unit that monitors the connection/non-connection state of each terminal apparatus to the communication line; a threshold value storage unit that stores a threshold value that serves as a determination criterion for shifting the image processing apparatus from an operation state to a standby state; and a control unit that controls the shifting of the image processing apparatus from the operation state to the standby state, using the use frequency information management table, the monitoring unit and the threshold value storage unit,
the power control program being stored in a computer-readable recording medium and causing a computer serving as the control unit to execute the steps of:
identifying terminal apparatuses that are connected to the communication line by the monitoring unit;
obtaining the use frequency information for all terminal apparatuses that have been identified to be in the connected state from the use frequency information management table and adding the obtained use frequency information;
comparing a total value obtained by the addition with the threshold value stored in the threshold value storage unit; and
as a result of the comparison, if the total value is smaller than the threshold value, outputting a signal instructing the image processing apparatus to shift to the standby state to the image processing apparatus; and
as a result of the comparison, if the total value is larger than or equal to the threshold value, outputting a signal instructing the image processing apparatus to maintain the operation state to the image processing apparatus.

18. A computer-readable recording medium in which the power control program according to claim 17 is recorded.
